(19) United States
(12) Patent Application Publication
(10) Pub. No.: US 2025/0104261 A1
(43) Pub. Date: Mar. 27, 2025

(54) COMPUTERIZED METHOD FOR MEASURING A PRODUCTION PALLET FOR PRECAST CONCRETE COMPONENT PARTS AND/OR A COMPONENT ARRANGED ON THE PRODUCTION PALLET

(71) Applicant: EBAWE Anlagentechnik GmbH, Eilenburg (DE)

(72) Inventor: Marcus Scheler, Eilenburg (DE)

(21) Appl. No.: 18/888,743

(22) Filed: Sep. 18, 2024

(30) Foreign Application Priority Data
Sep. 27, 2023 (EP) 23 199 970.7

(51) Int. Cl. G06T 7/62

(52) U.S. Cl. CPC G06T 7/62; G06T 2207/10028

(57) ABSTRACT

A computerized method for measuring a production pallet for precast concrete component parts for the construction industry and/or at least one component, preferably at least one precast concrete component part, preferably wall element, ceiling element and/or double wall element, arranged on the production pallet. The method includes: moving the production pallet relative to at least one measuring device, preferably via a gantry or a cantilever arm, to scan the production pallet, creating at least one depth image in a direction orthogonal to the production pallet by the at least one measuring device, and determining a production pallet height and/or a production height of at least one component arranged on the production pallet orthogonal to the production pallet by a computing unit via the at least one depth image in at least two positions of the production pallet spaced apart from each other.

### BACKGROUND OF THE INVENTION

The invention relates to a computerized method for measuring a production pallet for precast concrete component parts for the construction industry and/or at least one component, preferably at least one precast concrete component part, preferably wall element, ceiling element and/or double wall element, arranged on the production pallet. The invention also relates to a computer program product. The invention furthermore relates to a production system comprising a production pallet for producing at least one precast concrete component part for the construction industry and at least one measuring device, wherein the production pallet can be moved relative to the at least one measuring device to scan at least one precast concrete component part arranged on the production pallet.

Conventionally, precast concrete component parts for the construction industry are precast in production plants and then transported to the respective construction site for assembly. Accordingly, it is of significant importance to prevent, as far as possible, quality defects, variations in quality and/or manufacturing-related component part tolerances, which in particular make correct assembly difficult and/or impair a visual appearance of the precast concrete component parts when installed, as complex post-processing of the precast concrete component parts on site is necessary otherwise. In particular, in the case of double wall elements, accurate relative positioning of two precast concrete component parts (of the upper and lower shells of the double wall element) is essential. First approaches to a corresponding quality control for such precast concrete component parts are associated with large expenditure in terms of time and resources, as personnel have to manually measure a production height of the precast concrete component part in a discrete number of positions of the precast concrete component part and then infer possible post-corrections on the basis of the measuring points recorded by hand. In addition, the personnel need to rely on the production pallet being in a proper state for the manufacture of the precast concrete component parts.

The objective technical problem of the present invention is therefore to specify a method for measuring production pallets and/or components arranged on the production pallet that is improved compared with the state of the art as well as a computer program product and a production system in which the disadvantages of the state of the art are at least partially remedied and which are in particular characterized by an efficient and precise process of quality assurance.

### SUMMARY OF THE INVENTION

Therefore, according to the invention, the following method steps are carried out:
the at least one precast concrete component part is arranged on the production pallet,
the production pallet is moved relative to at least one measuring device, preferably via a gantry or a cantilever arm, to scan the at least one precast concrete component part,
at least one depth image in a direction orthogonal to the production pallet is created by the at least one measuring device,
a production pallet height and/or a production height of the at least one precast concrete component part orthogonal to the production pallet is determined by a computing unit via the at least one depth image in at least two positions of the production pallet spaced apart from each other.

It is thereby made possible for the first time that an overview of the existing component part tolerances as well as any geometry deviations of the precast concrete component parts still to be corrected can be provided to an operator of a production system for precast concrete component parts quickly and conveniently. For example, on the basis of the production heights ascertained (possibly based on the existing spacings of precast concrete component parts from each other), a visual or acoustic signal can convey to the operator that the standards of quality of the shape of the precast concrete component parts are sufficient. In the event of deviating production heights of individual precast concrete component parts, a plan for positional changes or-in the case of already cured concrete-grinding work in specific positions of the respective precast concrete component part can for example be visualized via an HMI (human-machine interface) or a computer. However, the invention is not limited to the analysis of precast concrete component parts. For example, it is possible for only the production pallet in the existing geometry or the positioning of at least one spacer and/or a reinforcement and/or a formwork element, as component(s) arranged on the production pallet, to be analyzed or examined before and/or after concrete is arranged on the production pallet, in order to be able to influence the production process at an early stage, for example because of incorrect positioning and/or soiling and/or wear and tear. The precast concrete component part is preferably analyzed or examined—as the end product or possibly during the production process (for example based on parts of the precast concrete component part).

In addition, as an add-on or plug-in for retrofitting existing production systems the at least one measuring device and/or the computing unit can be utilized in a user-friendly manner for the analysis of the depth images generated via the at least one measuring device. In general, whether the production pallet and/or the at least one measuring device is moved is as desired.

Furthermore, a degree of wear and tear and/or an existing geometry and/or soiling of the production pallet can be recorded. As a result, a production pallet can for example be separated out or post-processed if it does not have a sufficient flatness.

Moreover, the at least one measuring device with the data acquired thereby can be decoupled from the software for processing and evaluating the information of the measurement signals via a specific measurement principle, with the result that adaptations are easy to carry out both on the at least one measuring device and on the software—in particular in the case of changed requirements of the analysis of the precast concrete component parts.

Since the production height can be recorded as a vertical spacing (in the z direction) of a top side of the precast concrete component part relative to a reference point (in general the underside of the precast concrete component part in the production pallet plane as reference plane) at at least two points (in general of an existing continuum of measuring points substantially corresponding to the measurement accuracy and distributed over the precast concrete component part) in the x-y plane oriented orthogonal thereto, a flatness of the precast concrete component part (or of the production pallet) can also be derived via an existing thickness of the precast concrete component part or a layer thereof. A measurement of relative positions in the x-y plane is generally not necessary.

The technical term depth image can also be referred to as a depth map, wherein 3D information, with which a height of the objects to be imaged can be inferred, is to be taken from the depth image.

The production height is merely a preferred quality parameter for precast concrete component parts, the exceeding of threshold values by which relative to target values can necessitate a post-processing of the precast concrete component parts—preferably during the production process, when concrete is liquid or at least not completely cured. For example, angle, flatness, contour specifications for the geometry, et cetera can represent further quality parameters, wherein for example an angle of an outer contour can be derived through at least two production heights of the precast concrete component part. Extrapolations to derived variables such as a flatness of the precast concrete component part, which are quickly recognizable despite any existing complexity in the calculation, are preferred in order to be able to output possible recommended actions to personnel for error correction or an automated post-processing on the precast concrete component part by a processing device of the production system.

Through the provision of height information of the precast concrete component part during or just after the production process, the geometry of the end product can still be influenced before the concrete cures by displacement, pushing in or removal of a reinforcement or one half of a double wall part without complex post-processing steps such as grinding work being necessary. In particular, in the case of double wall parts, which have at least two visible faces when in use, a correct shape is of great importance.

Added to this is the positive property that resources can be saved in the production of the precast concrete component parts via the at least one depth image, since a processed volume of concrete can be inferred and/or information about deviations from a required minimum production height of the precast concrete component part is available. A quantity of concrete to be processed can thus be efficiently adjusted to a minimum required amount.

In particular, the alignment and/or height of a reinforcement and/or of further components of the component part such as spacers can be ascertained using the method. This brings about the advantage that, for example, collisions when turning a double wall half can be prevented through correction of the position at an early stage and an undesired geometry of the precast concrete component part can also be influenced preventively by for example altering the position of the reinforcement (in terms of the position in the production pallet plane or in terms of the height). An adjustment can thus be effected in production both before and after a concrete casting process step via the at least one depth image.

For example, a double wall half can be analyzed before the second double wall half is turned—possibly before the introduction of concrete and after the introduction of concrete—and/or the double wall element can be analyzed after the turning.

In addition, it is conceivable to derive a mechanical and/or thermal stress using the height information of the precast concrete component parts and possibly to intervene in the production process. For example, the mechanical stress can be caused by a displacement of spacing components.

Both the depth images and the evaluations of the depth images can be stored and utilized, for example, as a history for extrapolations or an artificial intelligence. As a result, a production process can be improved and the relevant information content can be filtered and presented to a user of the system at a glance.

In the case of precast concrete component parts in the form of double wall elements, an important quality parameter, which manifests itself in the production height of the double wall element after the upper shell has been turned and placed in the lower shell, is the spacing of the precast concrete component parts contained, preferably across the double wall element, wherein the production height is to be interpreted in such a broad way that the spacing or the production height of a shell as a thickness—possibly together with a protruding reinforcement—or parts of the precast concrete component part is also comprised by the production height.

The spacing can for example be calculated, via a difference between the production height of a double wall element and the production heights of the precast concrete component parts contained, as a production height of the reinforcement between the precast concrete component parts as part of the precast concrete component part. The production height is not limited to external dimensions of the precast concrete component part. Added to this is the positive property that the at least one measuring device is easily adaptable to given requirements and scalable with respect to the dimensions to be imaged. The software for evaluating the depth images is also flexibly adjustable in terms of the desired functionality.

The at least one precast concrete component part can generally be present in the cured state of the concrete contained or in a state before curing, preferably with liquid or still malleable concrete.

As stated at the beginning, protection is also sought for a computer program product comprising commands which, when executed by a computing unit, prompt the latter to create at least one depth image in a direction orthogonal to a production pallet using at least one measuring device and to determine a production pallet height and/or a production height of at least one component, preferably precast concrete component part, arranged on the production pallet orthogonal to the production pallet via the at least one depth image.

If depth images have been acquired by the at least one measuring device—for example via a laser and a camera—the computer program product, as software, can combine the depth images (e.g. as distance points along a width of the production pallet) into an overall depth image, in order to make it possible to infer the existing geometry of the precast concrete component part. Production data can be integrated here in order to be able to ascertain deviations (e.g. of the production heights) from target values. The production data can be utilized in order to derive search and reconstruction requests within the image data plane of the depth images. Through suitable pre-processing of the depth images—for example morphological transformation and/or bandpass filtering—the depth images can be prepared such that the edges of the production pallet, of formworks and/or elements are measured and/or reconstructed.

For example, in a first step, the production pallet can be reconstructed as an object by measuring edges of the production pallets and storing them as traverse points. The edge can for example be detected via a convolution kernel, in order to fit the measuring points as a 3D line by means of statistical reconstruction methods. A production pallet zero point can be transformed or defined as a reference point from the measurement information of the depth images.

The measuring points of the at least one measuring device can be realized on bandpass-filtered image data—e.g. on the lower shell or upper shell of the double wall element depending on the search query—wherein the lower shell, as a precast concrete component part of the double wall element, can be reconstructed indirectly via the measurement of the formwork elements.

The reconstructed edges on the production pallet can be represented as 3D lines, and traverse points can be derived. In order to be able to calculate precise height and/or position information of the precast concrete component parts and/or regions thereof relative to each other, the surface of the upper shell and of the production pallet can for example be measured with randomized points and fitted to a correction surface, which can then be utilized to correct the height information in order to be able to ascertain the positions of the lower shell relative to the upper shell substantially without systematic position errors with respect to the production pallet during the movement relative to the at least one measuring device.

From the generated data on actual and target points, a layer position correction recognition can be applied, which determines all six degrees of freedom (x, y, z, roll, pitch, yaw) as quality-assurance features and which can be compared with a system specification guide value, and/or a recommended correction or action can be generated.

In the software in the form of the application as a computer program product, non-compliance with a quality feature—for example a production height of the precast concrete component part that is too high or a double wall element that is not level enough—can be output as an error message or recommended correction in order for example to make personnel aware of recommended actions on a display device of the production system.

The algorithm or logic for evaluating the depth images of the at least one measuring device can be implemented as a layer model and is not limited to specific data variables or metrics. Different resolution qualities and/or image sizes can be covered, wherein the computer program product can be formed independent of a control and/or regulating device for creating the depth images via the at least one measuring device. The computer program product can be designed cloud-based, wherein a plurality of quality assurance processes for precast concrete component parts can be handled in parallel (preferably via the same vision server logic circuit).

Search information and/or transformation algorithmics can be chosen in dependence on the production data.

Reconstruction algorithmics and/or 3D correction of edges or faces of the precast concrete component part (e.g. of the upper and/or lower shell of the double wall element) are/is preferred.

A correction division logic circuit is particularly preferably used for recommended corrective actions.

As stated at the beginning, protection is also sought for a production system comprising a production pallet for producing at least one precast concrete component part for the construction industry and at least one measuring device, wherein the production pallet can be moved relative to the at least one measuring device to scan the production pallet and/or at least one component, preferably precast concrete component part, arranged on the production pallet, wherein the at least one measuring device is formed to create at least one depth image of the production pallet and/or at least one component, preferably precast concrete component part, arranged on the production pallet in a direction orthogonal to the production pallet in at least two positions spaced apart from each other and the production system comprises a computing unit which is set up to determine a production pallet height and/or a production height of at least one component, preferably precast concrete component part, arranged on the production pallet in dependence on the at least one depth image.

The computing unit can be regarded as an interface between the at least one measuring device and a visualization device for conveying recommended actions for the correction of the at least one precast concrete component part (or indicating that there is a sufficient quality without post-processing) in terms of the dual function of preparing the depth images and processing the information content contained in the depth images.

According to an advantageous embodiment of the invention, the at least one depth image is ascertained via laser triangulation of at least one laser triangulation unit of the at least one measuring device. The at least one depth image is recorded by at least one camera, preferably FPGA camera, of the at least one measuring device.

An FPGA camera can, in the sense of a pseudo line scanner, provide data for the further algorithmic processing, in order to ascertain the height information—resolved over the width of the production pallet—which is assigned to the respective coordinate along the production pallet.

The at least one camera is preferably arranged at an angle relative to the imaging plane or the at least one laser triangulation unit. A plurality of cameras are particularly preferably utilized to form an active stereo vision system.

In general, the at least one measuring device has a resolution of 1 mm per pixel in the production pallet movement direction x and orthogonal thereto in y, wherein there can be a maximum production pallet movement speed of 0.5 m/s. The resolution in x and y and the resolution of the measurement height in z can be calibrated independently of each other. The resolution in z can result from a camera position, the camera resolution and/or the maximally calibrated height. A coarser resolution in the x-y direction makes a higher production pallet movement speed possible, and vice versa.

By means of the measurement principle of laser triangulation, distances between edges of the at least one precast concrete component part and the production pallet in the vertical direction can be recorded particularly favorably without complex apparatuses and high system requirements, in order to make it possible to efficiently infer the existing shape of the at least one precast concrete component part in the course of the manufacturing process.

Advantageously, a plurality of laser triangulation units and/or cameras are arranged on the at least one measuring device in a row orthogonal to the movement direction of the at least one measuring device.

Wide precast concrete component parts can thereby be imaged over the entire width in the course of a single translational movement of the at least one measuring device.

Preferably, the at least one measuring device is designed to determine production heights of the at least one precast concrete component part of between 10 mm and 600 mm. The production height of the at least one precast concrete component part is determined between 10 mm and 600 mm.

For example, a double wall element has a production height of 500 mm, wherein a spacing between the two precast concrete component parts of 200 mm is possibly determined as the production height of the precast concrete component part via depth images in the edge region and in the center of the double wall element. For example, in the case of a production height of 500 mm result values can vary in the range of from 1% to 3% depending on a quality defect, with the result that, for example, a production height of 505.2 mm is measured in one corner of the precast concrete component part and a production height of 499.2 mm is measured in another corner. An absolute, maximum deviation from an expected value of 500 mm (of 5.2 mm in the case described) and/or a relative deviation over the measured points (of 6 mm in the case described) can be compared with a threshold value in order, where necessary, to indicate a post-processing if it is exceeded.

A height resolution of 2.5 mm can be generated in the case of a measurement height of 600 mm. Depending on a calibration to a particular measurement height and possibly through adjustment of a camera position, the height resolution can be increased, preferably to approximately 1 mm, particularly preferably into the μm range.

According to an advantageous embodiment of the invention, at least two precast concrete component parts are connected to form a double wall element, preferably with at least one reinforcement arranged between the at least two precast concrete component parts and/or via a turning device for turning.

It has proved to be advantageous that a spacing of the two precast concrete component parts relative to each other is determined as the production height in at least two positions of the double wall element spaced apart from each other.

However, it is sufficient to determine the overall thickness of the precast concrete component part as the production height, in order to derive therefrom deviations from a target geometry parameter. In multipart production processes, such as for double wall elements, first a production height of the lower shell as a precast concrete component part—possibly taking the reinforcement into consideration—and then of the double wall element as a precast concrete component part can for example be determined. As a result, the upper shell of the double wall element can for example be inserted into the lower shell such that no post-processing steps are necessary, because for example there is no collision with components of the lower shell (it is in principle also conceivable to base the turning process on the data of the analyzed lower shell, in order to carry out a particularly favorable turning of the upper shell).

An advantageous variant of the present invention is that the at least one depth image, preferably with the production pallet as reference plane, is created and evaluated during a concrete curing process of the at least one precast concrete component part.

It can thereby be guaranteed that a possibly necessary post-processing of the at least one precast concrete component part can still be carried out before a complete curing of the concrete of the at least one precast concrete component part, which makes the post-treatment of the at least one precast concrete component part to be processed easier.

It is particularly preferred that the at least one depth image is created as an 8-bit depth image and/or derived from a point cloud, preferably produced by means of 3D stereo vision or structured light.

A minimum standard can be ensured by a sufficient information content being contained in the recorded data, in order to be able to ascertain a distance of one edge relative to a further edge. Higher resolutions and/or image qualities are possible, but not imperative.

An optical depth analysis or a CT technique is in general possible as an alternative or in addition.

In an embodiment of the invention, the at least one depth image and at least one production parameter, preferably formwork parameter, are supplied to an image data processing logic circuit. The at least one depth image is reconstructed using an algorithm via the at least one production parameter, and preferably the at least one depth image is prepared by morphological transformation and/or bandpass filtering.

Through the at least one production parameter, it can be ensured that the ascertained actual values of the at least one precast concrete component part are compared with the correct target values according to the production order in an automated manner.

The signal processing of the data from the at least one measuring device is particularly preferably carried out in a logic circuit which comprises a recognition of the edges of the production pallet and/or of the precast concrete component part and/or a reconstruction of the edges and/or heights relative to the production pallet, in order to be able to generate a target/actual comparison between the actually existing production heights and a specific target value for the height or a threshold value range around the specific target value for the height.

According to a preferred embodiment of the invention, via an algorithm for the correction recognition of the at least one precast concrete component part, a deviation of the production height of the at least one precast concrete component part and/or of a possibly present spacing of two precast concrete component parts from a target value can be determined, preferably on the basis of the at least one possibly supplied production parameter. Using the algorithm, a recommended correction for the post-processing of the at least one precast concrete component part is created depending on the deviation determined.

A plan can thereby be created in an automated manner as a recommended action for the operator of the production system, on the basis of which the post-processing is to be effected. In place of the operator, a robot can for example be automatically instructed for the automated post-processing.

It has proved to be favorable that a deviation of dimensions of the at least one precast concrete component part from target values is determined in at least three degrees of freedom, preferably six degrees of freedom.

In general, in addition to a production height of the at least one precast concrete component part or a spacing of precast concrete component parts, an appraisal of further shape-related aspects of the at least one precast concrete component part, which can be recorded in a plurality of degrees of freedom by acquiring actual values of the at least one precast concrete component part via the at least one depth image, is also preferred for quality assurance, in order for example to be able to image and remedy a tilt of a surface or a twisting of the at least one precast concrete component part.

Furthermore, it is preferably provided that the at least one precast concrete component part is post-processed depending on the recommended correction.

Particularly preferably, a post-processing of the precast concrete component part is effected before the concrete cures, preferably on the production pallet.

In an embodiment of the computer program product, depending on at least one production parameter supplied to the computer program product:
the at least one depth image is reconstructed, and/or
a deviation of the production height from a target value is determined, and/or
a recommended correction for the post-processing of the at least one precast concrete component part is created.

### BRIEF DESCRIPTION OF THE DRAWINGS

Further details and advantages of the present invention are explained in more detail in the following with the aid of the description with reference to the drawings, in which:

FIG. 1 shows a production system according to a preferred embodiment for carrying out a method according to the invention in a schematic perspective representation,

FIG. 2 shows a turning device according to a first embodiment with a production pallet on which a precast concrete component part is arranged for the manufacture of a double wall element, in a perspective view,

FIG. 3 shows a turning device according to a second embodiment during a turning of a precast concrete component part to be placed in a second precast concrete component part to form a precast concrete component part in the form of a double wall element, FIG. 4 shows a production pallet with three precast concrete component parts, arranged on a turning device, in a top view,

FIG. 5 shows a production system according to a further preferred embodiment for carrying out a method according to the invention in a schematic perspective representation,

FIGS. 6a-6c are analyzed depth images of precast concrete component parts arranged on a production pallet with a recommended action for the post-processing of precast concrete component parts,

FIGS. 7a, 7b are intensity images of precast concrete component parts arranged on a production pallet for the processing by a computing unit,

FIGS. 7c, 7d are depth images of the precast concrete component parts arranged on the production pallet for the processing by the computing unit.

### DETAILED DESCRIPTION OF THE INVENTION

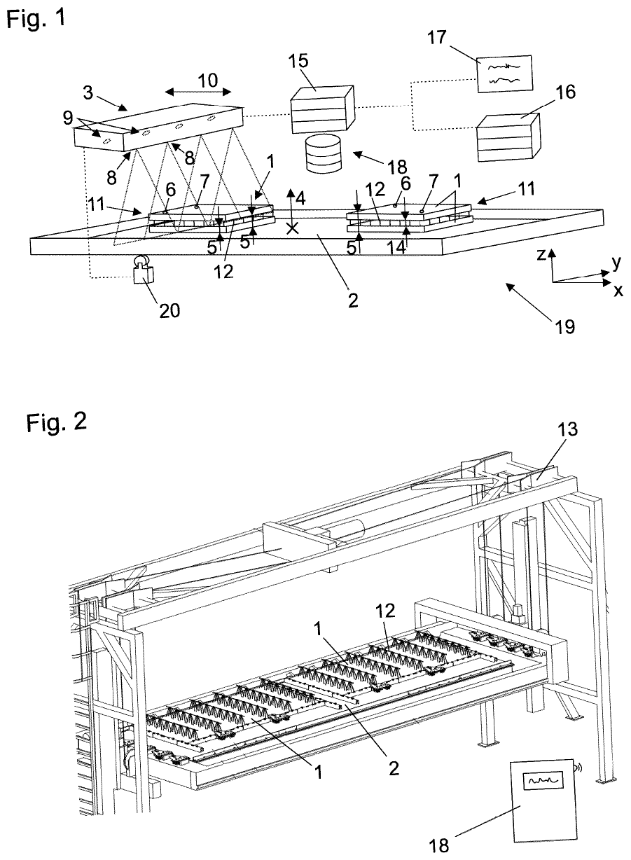

FIG. 1 shows a production system 19 comprising a production pallet 2 for producing precast concrete component parts 1 for the construction industry with two precast concrete component parts 1 in the form of double wall elements 11 arranged on it, which are each composed of two precast concrete component parts 1. The two precast concrete component parts 1 of the double wall element 11 are connected to each other via a reinforcement 12.

The production system 19 has a measuring device 3, which can be moved relative to the production pallet 2 to scan the precast concrete component parts 1 arranged on the production pallet 2.

The measuring device 3 comprises a plurality of laser triangulation units 8 and cameras 9 in a row orthogonal to the movement direction 10 of the measuring device 3. In the embodiment of the production system 19 represented, four laser triangulation units 8 are each equipped with a camera 9 and arranged on the measuring device 3 such that the entire width of the production pallet 2 can be imaged in the course of the movement of the measuring device 3. However, the number of laser triangulation units 8 and cameras 9 is generally as desired.

An encoder 20 is in data-signal-carrying connection, wherein it is generally unimportant whether the data connection to the measuring device 3 is designed to be radio-signal-transmitting or wired. Via the encoder 20, in the case of a connection to the production pallet 2 without slip for the measuring device 3, an item of precise information for the x coordinate (in the longitudinal direction of the production pallet 2) can be generated, which is fed to the measuring device 3 in order to be able, with the information for the y coordinate (in the width direction of the production pallet 2), to infer the heights relative to the production pallet 2.

The measuring device 3 is programmed to create depth images with respect to an orthogonal direction 4 relative to a plane spanned by the production pallet 2 in at least two positions 6, 7 spaced apart from each other, wherein a continuum of depth images is preferably generated over the longitudinal extent and width of the precast concrete component parts 1, in order to assemble the depth image from a point cloud of measuring points of production heights 5 over the width of the respective precast concrete component part 1. The two positions 6, 7 indicated by a circle in the image only represent possible locations at production heights 5 (or spacings 14) to be determined.

In principle, it is sufficient to determine only the production height 5 as the thickness of the double wall element 11. This corresponds to the reference number 5 on the right in the representation. However, it is also possible to analyze the lower shell before the upper shell is turned, wherein the production height 5 of the layer of the double wall element 11—indicated by the reference number 5 on the left—and/or the production height 5 of the lower shell together with the reinforcement 12—indicated by the reference number 5 in the middle—is recorded and processed. It is possible to derive the spacing 14 of the upper and lower shells from the information obtained.

In this embodiment, an 8-bit depth image is created which is derived via 3D stereo vision or structured light. However, the measurement method for recording the production height 5 of the precast concrete component part 1 is generally as desired.

The production system 19 comprises a computing unit 18, which is implemented to determine the production height 5 of the precast concrete component parts 1 arranged on the production pallet 2 in dependence on the depth images at the respective location of the precast concrete component part 1, in order for example to be able to analyze a flatness of the precast concrete component part 1 at least in regions across the precast concrete component part 1 or a distancing of the two precast concrete component parts 1 of the double wall element 11 at least in regions across the double wall element 11.

Different production heights 5 are visible in the representation. The production height 5 on the left-hand precast concrete component part 1 in the representation illustrates that the production height 5 of the lower shell of the double wall element 11 can be recorded and analyzed before the upper shell is turned—possibly with a protrusion present due to the reinforcement 12. The production height 5 on the concrete component part 1 in the right-hand precast representation represents the production height 5 on the end product, which is possibly still to be corrected locally. Via this production height 5, a spacing 14 between the upper shell and the lower shell can be inferred. In principle, it is sufficient to record only the production height 5 on the double wall element 11 or of the precast concrete component part 1 as end product.

An example of a computerized method for measuring a precast concrete component part 1 for the construction industry can be explained as follows: the precast concrete component part 1 is arranged on the production pallet 2, then the measuring device 3 is moved relative to the production pallet 2 via a gantry or a cantilever arm to scan the precast concrete component part 1, with the result that, using the measuring device 3, a plurality of depth images are created in a direction 4 orthogonal to the production pallet 2, which are assembled to form an overall depth image of the precast concrete component part 1 in order to be able to infer a production height 5 of the precast concrete component part 1 orthogonal to the production pallet 2 using a computing unit 18 in at least two positions 6, 7 of the precast concrete component part 1 spaced apart from each other.

Through the depth images, the geometry of the production pallet 2 can in general—irrespective of any precast concrete component part 1 arranged on the production pallet 2—be analyzed in order to be able to infer, via the production pallet heights, wear and tear or soiling at least in regions across the production pallet 2.

The depth images ascertained via the measuring device 3—in particular via laser triangulation of the laser triangulation units 8 in conjunction with the associated (FPGA) cameras 9—are then analyzed by means of software.

The software for analyzing the depth images is generally independent of the principle of recording the depth images. In the embodiment shown, the depth images acquired via the measuring device 3 are processed and analyzed via at least one production parameter, such as a formwork parameter.

An image data processing logic circuit 15 utilizes an algorithm for the depth images which carries out a reconstruction of the depth images on the basis of the production parameter via morphological transformations or bandpass filtering for the preparation.

Via an algorithm for the correction recognition 16 of precast concrete component part 1, a deviation of the actually existing production height 5 of the precast concrete component part 1 or of the actually present spacing 14 of two precast concrete component parts 1 as the production height 5 from a target value is determined on the basis of the supplied production parameter, wherein, using the algorithm, a recommended correction 17 for the post-processing of the precast concrete component part 1 is created in dependence on the deviation determined and visualized on a display device for an operator of the production system 19.

The image data processing logic circuit 15, the correction recognition 16 and the recommended correction 17 are preferably programmed as applications, which can for example be present in an integral machine control system of the production system 19 with an interface or a remote control and/or regulating device for the production system 19.

Via a data carrier signal the applications can be transferred, which comprise a computer program product which contains commands which, when executed by the computing unit 18, prompt the computing unit 18 to create the depth images using the measuring device 3 and to determine production heights 5 of precast concrete component parts 1 or spacings 14—in general between an upper edge of the lower shell and a lower edge of the upper shell or a lower edge of the lower shell and an upper edge of the upper shell—of precast concrete component parts 1 via the depth images.

The supply of the production parameter for the processing of the depth images or recording and comparison of the production heights 5 or spacings 14 is not imperative, but preferred, in order to reconstruct the depth images particularly favorably, to determine deviations from target values or to create a recommended correction 17 for the post-processing of the precast concrete component parts 1.

FIG. 2 shows a turning device 13 for turning a first precast concrete component part 1 to be placed in a second precast concrete component part 1 to form a double wall element 11.

For example, the existing geometry of the second precast concrete component part 1, to be placed in which the first precast concrete component part 1 represented is to be turned, can already be analyzed via the measuring device 3 before the connection. It is also possible to analyze the first precast concrete component part 1 via the measuring device 3 before the connection to the second precast concrete component part 1. After the double wall element 11 has been formed, the existing geometry—such as the spacings 14 in different positions 6, 7—of the individual precast concrete component parts 1 or the double wall element 11 as such can be analyzed via the measuring device 3.

The measuring device 3 according to FIG. 1 is designed to cover production heights 5 of the precast concrete component part 1 or of the double wall element 11 of between 10 mm and 600 mm.

In the analysis of the depth images, the production pallet 2 can serve as a reference plane, which is identified by the software in the course of the analysis of the depth images.

If the depth images are created and evaluated during a concrete curing process of the precast concrete component parts 1, any necessary post-processing of the precast concrete component parts 1 can be effected particularly easily because the material of the precast concrete component parts 1 is even easier to process.

A deviation of dimensions of the respective precast concrete component part 1 from target values above a predefined threshold value causes an output to the operator, in order to be able to initiate the required post-processing steps in dependence on the recommended correction 17—possibly guided by the application. The dimensions of the precast concrete component parts 1 are preferably determined in six degrees of freedom for deviations from target values.

The turning device 13 comprises a gantry for positioning holding-down elements on variably positionable edge formworks. This gantry can be utilized to receive the measuring device 3. A gantry or a cantilever arm as an alternative or in addition to the gantry for positioning the holding-down elements is likewise possible.

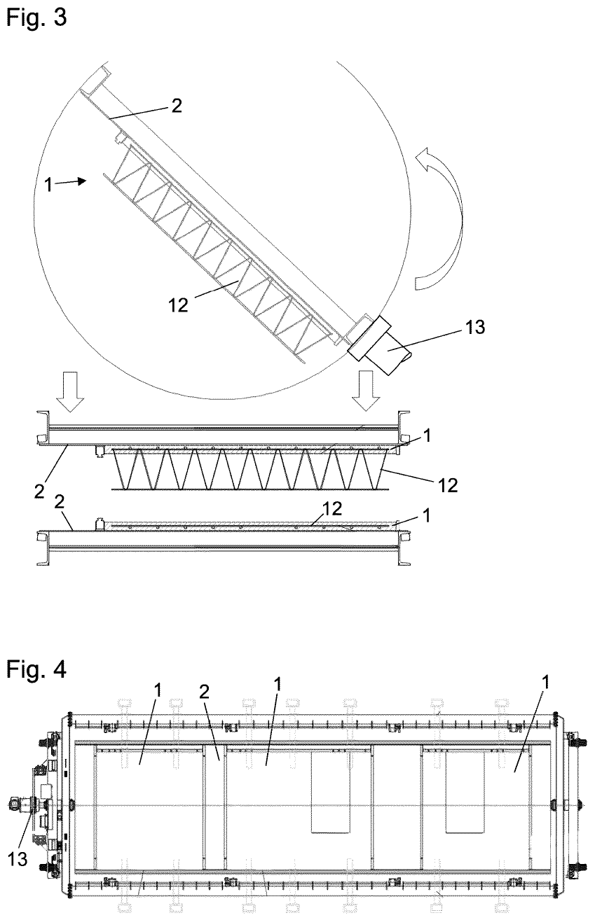

FIG. 3 shows a turning device 13 for double wall elements 11, wherein, unlike the turning device 13 with a lifting device according to FIG. 2, a robot arm is used to turn the precast concrete component parts 1.

The type of reinforcement 12 is generally as desired and can for example be in the form of lattice girders, bars, stirrups, or reinforcement mesh.

FIG. 4 shows a production pallet 2 with three precast concrete component parts 1 arranged on it, wherein the left-hand precast concrete component part 1 can for example serve as a ceiling element and the two further precast concrete component parts 1 can serve as wall elements. With variably positionable edge formworks, complex geometries can be made out of concrete in order for example to be able to integrate windows or doors in the form of the precast concrete component parts 1.

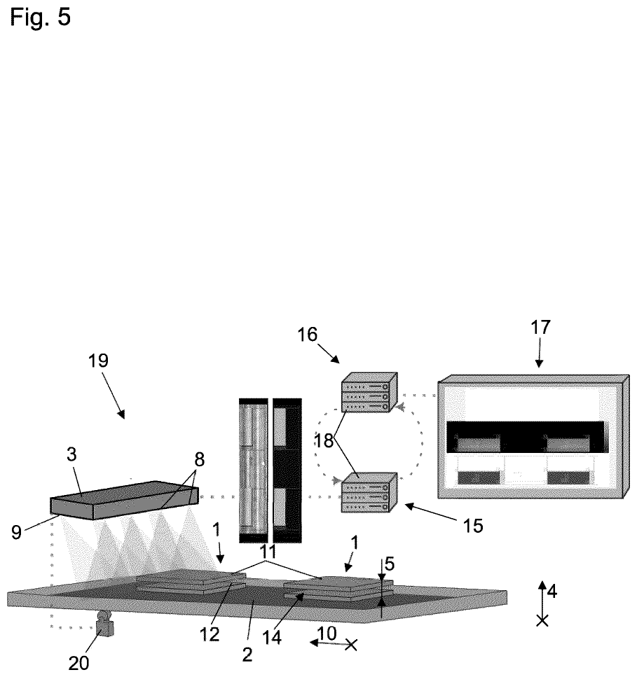

FIG. 5 shows a production system 19 for carrying out the method for measuring precast concrete component parts 1, wherein it can be seen that the cameras 9 are oriented at an angle to the section plane of the laser triangulation units 8.

The image data of the double wall element 11 are supplied from the measuring device 3 to a data processing unit, which determines from the information recommended actions for the correction and/or post-processing, which are visualized on a display device.

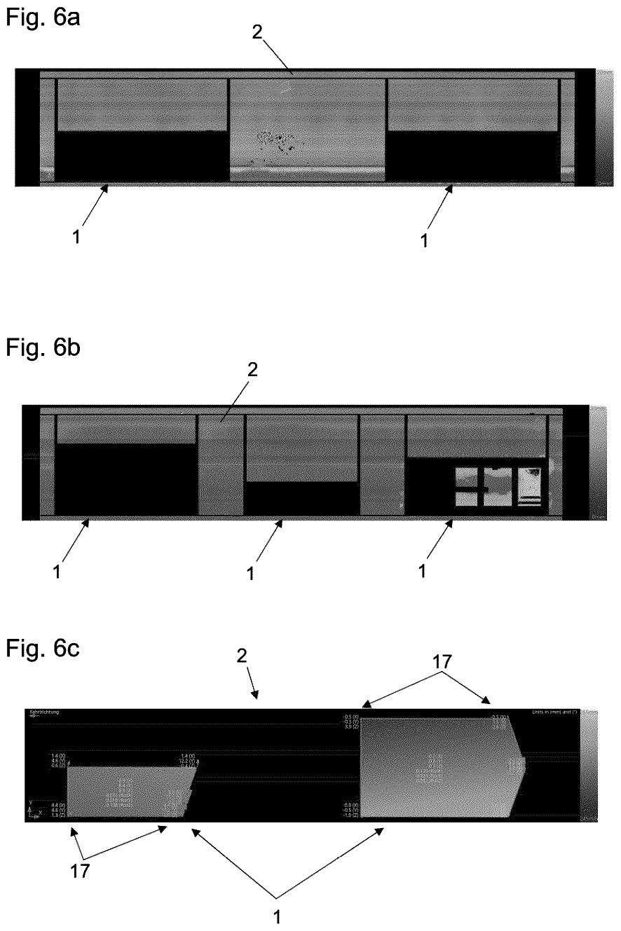

FIG. 6a shows height information about a production pallet 2 on which two precast concrete component parts 1 are arranged. In the middle of the production pallet 2, the production pallet 2 is soiled with concrete, wherein this issue has been recorded by the image processing logic circuit. In an analogous manner, the degree of wear of the production pallet can be inferred, which influences the geometry of the precast concrete component part 1.

Via the recording of the production pallet surface in its entirety, there is the possibility of developing a metric for assessing the inhomogeneity and/or quality of the production pallet surface in order, where necessary, to exclude the production pallet 2 from the production process. For example, the production pallet height might not be constant due to the appearance of wear and tear (or soiling) and might be lower or higher, in regions, than in the adjacent region of the production pallet 2. On the one hand this can be taken into consideration for post-processing on the precast concrete component part 1 and on the other hand a separating out of the production pallet 2 can be ensured in the case of differences in the production pallet height above a threshold value. A plane which corresponds to an average or predominantly existing production pallet height can be chosen as reference plane with respect to the production pallet height, in order to be able to ascertain deviations therefrom.

FIG. 6b shows height information of three precast concrete component parts 1 relative to the production pallet 2 as reference plane. One precast concrete component part has openings—for windows.

FIG. 6c shows a recommended action in the form of a recommended correction 17 for two precast concrete component parts 1 derived from the depth images of the measuring device 3.

It is a heatmap/colormap representation of a surface model fitted from surface measurements, on which a change in a measured height profile can be visualized graphically for the operator—in particular in a comprehensible and quickly recognizable manner—in order to be able to serve as an action instruction as regards corrections.

The respective precast concrete component part 1 can be displaced, pivoted or the like corresponding to the indicated coordinate displacements to set a target state of the precast concrete component part 1.

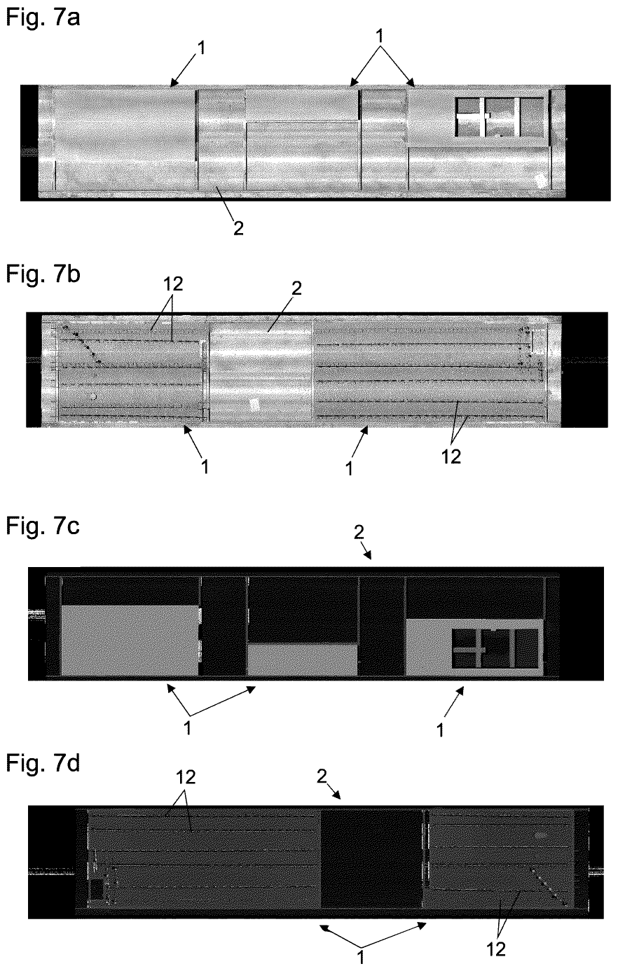

FIG. 7a shows an intensity image, produced from the measuring device 3, of the production pallet 2 with three precast concrete component parts 1 arranged on it, in order, where necessary, to be able to determine any deviations from geometry target values.

FIG. 7b shows a production pallet 2, on which two double wall parts in the form of precast concrete component parts 1 for two double wall elements 11 as precast concrete component parts 1 are arranged, in the form of an intensity image produced via the measuring device 3.

Through the analysis of the precast concrete component parts 1—in particular of the reinforcements 12 protruding from the lower shells of the double wall elements 11 and/or positioned spacers—the geometry of the double wall element 11 as end product can already be influenced before the upper shell is turned; for example by displacing or tilting a reinforcement 12 relative to the adjacent concrete.

FIG. 7c and FIG. 7d show intermediate data processing steps between a transmission of the depth images from the measuring device 3 to the computing unit 18 and the derivation of recommended corrections 17 by the computing unit 18. FIG. 7c and FIG. 7d show overall depth images, generated from the depth images of the measuring device 3, of the production pallet 2 with the precast concrete component parts 1 arranged on it. The depth images are produced via the measuring device 3.

The intensity images according to FIG. 7a and FIG. 7b as well as the depth images/overall depth images according to FIG. 7c and FIG. 7d are produced by the measuring device 3 and are present in unprocessed and unfitted form, respectively. These can be utilized as input data for the image evaluation logic circuit.

1. A computerized method for measuring a production pallet for precast concrete component parts for the construction industry and/or at least one component, preferably at least one precast concrete component part, preferably wall element, ceiling element and/or double wall element, arranged on the production pallet, the method comprising:
moving the production pallet relative to at least one measuring device, preferably via a gantry or a cantilever arm, to scan the production pallet,
creating at least one depth image in a direction orthogonal to the production pallet by the at least one measuring device, and
determining a production pallet height and/or a production height of at least one component arranged on the production pallet orthogonal to the production pallet by a computing unit via the at least one depth image in at least two positions of the production pallet spaced apart from each other.

2. The method according to claim 1, wherein the at least one depth image is ascertained via laser triangulation of at least one laser triangulation unit of the at least one measuring device, wherein the at least one depth image is recorded by at least one camera, preferably FPGA camera, of the at least one measuring device.

3. The method according to claim 1, wherein a plurality of laser triangulation units and/or cameras are arranged on the at least one measuring device in a row orthogonal to the movement direction of the at least one measuring device.

4. The method according to claim 1, wherein the at least one measuring device is designed to determine production heights of the at least one precast concrete component part of between 10 mm and 600 mm, wherein the production height of the at least one precast concrete component part is determined between 10mm and 600 mm.

5. The method according to claim 1, wherein at least two precast concrete component parts are connected to form a double wall element, preferably with at least one reinforcement arranged between the at least two precast concrete component parts and/or via a turning device for turning.

6. The method according to claim 5, wherein a spacing of the two precast concrete component parts relative to each other is determined as the production height in at least two positions of the double wall element spaced apart from each other.

7. The method according to claim 1, wherein the at least one depth image, preferably with the production pallet as reference plane, is created and evaluated during a concrete curing process of the at least one precast concrete component part.

8. The method according to claim 1, wherein the at least one depth image is created as an 8-bit depth image and/or is derived from a point cloud, preferably produced by means of 3D stereo vision or structured light.

9. The method according to claim 1, wherein the at least one depth image and at least one production parameter, preferably formwork parameter, are supplied to an image data processing logic circuit, wherein the at least one depth image is reconstructed using an algorithm via the at least one production parameter, wherein it is preferably provided that the at least one depth image is prepared by morphological transformation and/or bandpass filtering.

10. The method according to claim 1, wherein, via an algorithm for the correction recognition of the at least one precast concrete component part, a deviation of the production height of the at least one precast concrete component part and/or of a possibly present spacing of two precast concrete component parts from a target value is determined, preferably on the basis of the at least one possibly supplied production parameter, wherein, using the algorithm, a recommended correction for the post-processing of the at least one precast concrete component part is created in dependence on the deviation determined.

11. The method according to claim 10, wherein a deviation of dimensions of the at least one precast concrete component part from target values is determined in at least three degrees of freedom, preferably six degrees of freedom.

12. The method according to claim 10, wherein the at least one precast concrete component part is post-processed depending on the recommended correction.

13. The method according to claim 1, wherein a post-processing of the precast concrete component part is effected before the concrete cures, preferably on the production pallet.

14. A computer program product comprising commands which, when executed by a computing unit, prompt the latter to create at least one depth image in a direction orthogonal to a production pallet using at least one measuring device and to determine a production pallet height and/or a production height of at least one component, preferably precast concrete component part, arranged on the production pallet orthogonal to the production pallet via the at least one depth image.

15. The computer program product according to claim 14, wherein, depending on at least one production parameter supplied to the computer program product:
the at least one depth image is reconstructed, and/or
a deviation of the production height from a target value is determined, and/or
a recommended correction for the post-processing of the at least one precast concrete component part is created.

16. A production system comprising: a production pallet for producing at least one precast concrete component part for the construction industry and at least one measuring device, wherein the production pallet can be moved relative to the at least one measuring device to scan the production pallet and/or at least one component, preferably precast concrete component part, arranged on the production pallet, wherein the at least one measuring device is formed to create at least one depth image of the production pallet and/or at least one component, preferably precast concrete component part, arranged on the production pallet in a direction orthogonal to the production pallet in at least two positions spaced apart from each other and the production system comprises a computing unit which is set up to determine a production pallet height and/or a production height of at least one component, preferably precast concrete component part, arranged on the production pallet in dependence on the at least one depth image.
